(19) United States
(12) Patent Application Publication
(10) Pub. No.: US 2026/0073657 A1
(43) Pub. Date: Mar. 12, 2026

(54) SYSTEMS AND METHODS FOR SEGMENTATION USING RETRIEVAL AUGMENTATION

(71) Applicant: Samsung Electronics Co., Ltd., Suwon-si (KR)

(72) Inventors: Mostafa El-Khamy, San Diego, CA (US); Qingfeng Liu, San Diego, CA (US); Nafis Sadeq, La Jolla, CA (US)

(21) Appl. No.: 19/271,666

(22) Filed: Jul. 16, 2025

Related U.S. Application Data
(60) Provisional application No. 63/693,037, filed on Sep. 10, 2024.

(51) Int. Cl. G06V 10/26; G06F 16/535; G06F 16/56; G06V 10/74; G06V 10/764

(52) U.S. Cl. CPC G06V 10/26; G06F 16/535; G06F 16/56; G06V 10/761; G06V 10/764

(57) ABSTRACT

A system and a method are disclosed for classifying features from an input image. The method includes generating, by a processing circuit, a segment feature from a first input image, the segment feature corresponding to a group of pixels associated with an object represented in the first input image, and being an out-of-vocabulary segment feature; performing, by the processing circuit, a retrieval of a first feature vector, corresponding to the segment feature, from a database of feature vectors, the first feature vector representing an object-specific segmentation mask; and generating, by the processing circuit, an output segmentation mask based on the first feature vector.

### CROSS-REFERENCE TO RELATED APPLICATION

This application claims the priority benefit under 35 U.S.C. § 119 (c) of U.S. Provisional Application No. 63/693,037, filed on Sep. 10, 2024, the disclosure of which is incorporated by reference in its entirety as if fully set forth herein.

### TECHNICAL FIELD

The disclosure generally relates to systems and methods for segmentation in the field of computer vision. More particularly, the subject matter disclosed herein relates to improvements to systems and methods for panoptic segmentation.

### SUMMARY

In the field of computer vision, panoptic segmentation refers to methods for enabling a computer to understand a visual scene depicted in an image or in a video based on classifying and assigning an instance identification (ID) to each pixel in the image or video. For example, given an input image and a set of class names, panoptic segmentation aims to label each pixel in the input image with class labels and instance labels. For example, pixels making up a first person, in an image, may be assigned a first instance ID that distinguishes the first person from a second person, in the image, made up of pixels assigned a second instance ID. Some systems for panoptic segmentation focus on closed vocabulary panoptic segmentation, which relies on a fixed set of known classes (e.g., a known number of classes). Such systems may try to improve panoptic-segmentation performance by conducting a supervised learning on a training dataset with a set of predefined classes (e.g., a closed vocabulary) and by using specific architectures, specific loss functions, stronger backbones, and/or the like.

Panoptic segmentation may include a two-stage framework. For example, a first stage may include generating a class-agnostic mask proposal and the second stage may include using one or more pre-trained vision language models (e.g., a contrastive language-image pre-training (CLIP) model) to classify masked regions by aligning embeddings between a CLIP text encoder and a masked image region encoded with a CLIP vision encoder. In the field of computer vision, CLIP refers to a method for training two machine-learning (ML) models in parallel (e.g., a first neural network for image understanding and a second neural network for text understanding) using a contrastive objective (e.g., using a contrastive loss) in which output vectors from the two ML models corresponding to similar text-image pairs are close together in a shared vector space, while output vectors from the two ML models corresponding to dissimilar pairs are far apart in the shared vector space. Such methods may cause the CLIP vision encoder to suffer from poor quality (e.g., low quality) due to a limitation when encoding a masked image instead of encoding a full natural image. This poor quality of encoded features may hurt open vocabulary segmentation performance (e.g., when the number of classes is unknown).

Aspects of some embodiments of the present disclosure provide for improvements to systems and methods for panoptic segmentation by enabling systems to recognize and to categorize (e.g., to classify) objects even if they have not been specifically included in the training dataset (e.g., enabling systems for an open vocabulary). Open vocabulary panoptic segmentation aims to facilitate segmentation on arbitrary classes according to inputs (e.g., user inputs).

Aspects of some embodiments of the present disclosure provide for improvements to systems and methods for panoptic segmentation by using a retrieval-augmented approach.

Aspects of some embodiments of the present disclosure provide for a retrieval-augmented approach for panoptic segmentation, in which the system constructs a feature database for masked regions. At inference time, for both a cross-datasets setting (e.g., a cross-datasets system) and a training-free setting (e.g., a training-free system), the masked region features may be extracted from the input image and used as a retrieval key to retrieve similar features and associated class labels from the database. The masked region may be classified based on a similarity between the retrieval key and retrieval targets. The retrieval-based classification module may be combined with a CLIP-score classification module to improve open vocabulary panoptic segmentation performance.

Aspects of some embodiments of the present disclosure provide for systems with the capability to augment segmentation methods to work on a class (e.g., a new class), without specifically training system networks (e.g., ML models) for that class, by using retrieval augmentation to augment the knowledge of the system networks (e.g., trained networks). In some embodiments, augmentation may be performed at both the text-label level and the image-segmentation-mask level.

Aspects of some embodiments of the present disclosure provide for a retrieval augmentation module that uses text embedding (e.g., CLIP-text embedding) to retrieve the closest label to construct a feature database (e.g., a mask segment feature database), and CLIP-vision embedding of segment features (e.g., predicted masked segments) to retrieve the closest class labels from the feature database. As used herein, a “segment feature” refers to data corresponding to a group of pixels that are related to a same object or class within (e.g., represented in) an image and that make up less than the entire image (e.g., that make up a segment or a region). For example, a first segment feature of an image may be a first group of pixels that make up (e.g., that together depict) a horse within the image; a second segment feature of the image may be a second group of pixels that make up a sky within the image; and a third segment feature of the image may be a third group of pixels that make up grass within the image.

Aspects of some embodiments of the present disclosure provide for a model for a cross-datasets setting that fuses a retrieval augmentation result with a frozen convolutional CLIP (FC-CLIP) result.

Aspects of some embodiments of the present disclosure provide for a model for a training-free setting that fuses a retrieval augmentation result with a segment anything model (SAM) result and a CLIP result.

The above approaches improve on previous methods by increasing the quality of segmentation masks generated by systems for panoptic segmentation and by improving the performance of such systems for open vocabulary panoptic segmentation. For example, aspects of some embodiments of the present disclosure may enable improved panoptic quality (PQ), improved mean average precision (mAP), and/or improved mean intersection over union (mIoU) (e.g., improved overlap between results and ground truth).

According to some embodiments of the present disclosure, a method for classifying features from an input image includes generating, by a processing circuit, a segment feature from a first input image, the segment feature corresponding to a group of pixels associated with an object represented in the first input image, and being an out-of-vocabulary segment feature, performing, by the processing circuit, a retrieval of a first feature vector, corresponding to the segment feature, from a database of feature vectors, the first feature vector representing an object-specific segmentation mask, and generating, by the processing circuit, an output segmentation mask based on the first feature vector.

The method may further include generating a first classification score for the segment feature based on an output of a CLIP text encoder, generating a second classification score for the first feature vector based on a similarity between the segment feature and the first feature vector, and determining a final segmentation score based on the first classification score and the second classification score, wherein the output segmentation mask is generated based on the final segmentation score.

The method may further include generating the segment feature by sending input image data from the first input image to an object detector, and sending an output of the object detector to a segmentation model.

The method may further include generating the segment feature based on sending a dense feature from the first input image to a pixel decoder.

The method may further include generating the database of feature vectors by sending a dense feature from a second input image to an object detector, sending an output of the object detector to a segmentation model to generate a mask proposal, generating the object-specific segmentation mask based on the mask proposal, and generating the first feature vector based on the object-specific segmentation mask.

The first feature vector may be generated based on segment-to-text embedding, and the segment feature may be generated based on segment-to-vision embedding.

The performing of the retrieval may include performing a nearest-neighbor search based on the segment feature.

The method may further include performing a search in the database of feature vectors based on a second segment feature, and based on the search resulting in a miss, retrieving a second feature vector from a secondary dataset.

According to other embodiments of the present disclosure, a system for classifying features from an input image includes a processing circuit, and a memory storing instructions that, based on being executed by the processing circuit, cause the processing circuit to perform generating a segment feature from a first input image, the segment feature corresponding to a group of pixels associated with an object represented in the first input image, and being an out-of-vocabulary segment feature, a retrieval of a first feature vector, corresponding to the segment feature, from a database of feature vectors, the first feature vector representing an object-specific segmentation mask, and generating an output segmentation mask based on the first feature vector.

10. The instructions, based on being executed by the processing circuit, may cause the processing circuit to perform generating a first classification score for the segment feature based on an output of a CLIP text encoder, generating a second classification score for the first feature vector based on a similarity between the segment feature and the first feature vector, and determining a final segmentation score based on the first classification score and the second classification score, wherein the output segmentation mask is generated based on the final segmentation score.

The instructions, based on being executed by the processing circuit, may cause the processing circuit to perform generating the segment feature by sending input-image data from the first input image to an object detector, and sending an output of the object detector to a segmentation model.

The instructions, based on being executed by the processing circuit, may cause the processing circuit to perform generating the segment feature based on sending a dense feature from the first input image to a pixel decoder.

The instructions, based on being executed by the processing circuit, may cause the processing circuit to perform generating the database of feature vectors by sending a dense feature from a second input image to an object detector, sending an output of the object detector to a segmentation model to generate a mask proposal, generating the object-specific segmentation mask based on the mask proposal, and generating the first feature vector based on the object-specific segmentation mask.

The first feature vector may be generated based on segment-to-text embedding, and the segment feature may be generated based on segment-to-vision embedding.

The performing of the retrieval may include performing a nearest-neighbor search based on the segment feature.

The instructions, based on being executed by the processing circuit, may cause the processing circuit to perform a search in the database of feature vectors based on a second segment feature, and based on the search resulting in a miss, retrieving a second feature vector from a secondary dataset.

According to other embodiments of the present disclosure, a device for classifying features from an input image includes an image sensor configured to generate an input image, and a means for processing, the means for processing being configured to perform a method for classifying features from the input image, the method including generating, by the means for processing, a segment feature from a first input image, the segment feature corresponding to a group of pixels associated with an object represented in the first input image, and being an out-of-vocabulary segment feature, performing, by the means for processing, a retrieval of a first feature vector, corresponding to the segment feature, from a database of feature vectors, the first feature vector representing an object-specific segmentation mask, and generating, by the means for processing, an output segmentation mask based on the first feature vector.

The method may further include generating a first classification score for the segment feature based on an output of a CLIP text encoder, generating a second classification score for the first feature vector based on a similarity between the segment feature and the first feature vector, and determining a final segmentation score based on the first classification score and the second classification score, wherein the output segmentation mask is generated based on the final segmentation score.

The method may further include generating the segment feature by sending input-image data from the first input image to an object detector, and sending an output of the object detector to a segmentation model.

The method may further include generating the segment feature based on sending a dense feature from the first input image to a pixel decoder.

### BRIEF DESCRIPTION OF THE DRAWING

In the following section, the aspects of the subject matter disclosed herein will be described with reference to exemplary embodiments illustrated in the figures.

FIG. 1A is a block diagram depicting a system for classifying features from an input image in a cross-dataset setting, according to some embodiments of the present disclosure.

FIG. 1B is a block diagram depicting a system for classifying features from an input image in a training-free setting, according to some embodiments of the present disclosure.

FIG. 2 is a block diagram depicting a method for constructing a feature database for the systems of FIGS. 1A and 1B, according to some embodiments of the present disclosure.

FIG. 3 is a block diagram of an electronic device in a network environment, according to some embodiments of the present disclosure.

FIG. 4 is a flowchart depicting example operations of a method for classifying features from an input image, according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

Each of the terms “processing circuit” and “means for processing” is used herein to mean any suitable combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As discussed above, in the field of computer vision, panoptic segmentation refers to methods for enabling a computer to understand a visual scene depicted in an image or in a video based on classifying and assigning an instance identification (ID) to each pixel in the image or video. For example, given an input image and a set of class names, panoptic segmentation aims to label each pixel in the input image with class labels and instance labels. For example, pixels making up a first person, in an image, may be assigned a first instance ID that distinguishes the first person from a second person, in the image, made up of pixels assigned a second instance ID. Some systems for panoptic segmentation focus on closed vocabulary panoptic segmentation, which relies on a fixed set of known classes. Such systems may try to improve a performance of panoptic segmentation by conducting a supervised learning on a training dataset with a set of predefined classes (e.g., a closed vocabulary) and by using novel architectures, novel loss functions, stronger backbones, and/or the like.

Some methods for panoptic segmentation include a two-stage framework. For example, a first stage may include generating a class-agnostic mask proposal and the second stage may include using one or more pre-trained vision language models (e.g., a CLIP model) to classify masked regions by aligning embeddings between a CLIP text encoder and a masked image region encoded with a CLIP vision encoder. In the field of computer vision, CLIP refers to a method for training two ML models in parallel (e.g., a first neural network for image understanding and a second neural network for text understanding) using a contrastive objective (e.g., using a contrastive loss), in which output vectors from the two ML models corresponding to similar text-image pairs are close together in a shared vector space, while output vectors from the two ML models corresponding to dissimilar pairs are far apart in the shared vector space. Such methods may cause the CLIP vision encoder to suffer from poor quality due to a limitation when encoding a masked image instead of encoding a full natural image. This poor quality of encoded features may hurt open vocabulary segmentation performance.

Aspects of some embodiments of the present disclosure provide for improvements to systems and methods for panoptic segmentation by enabling systems to recognize and to categorize (e.g., to classify) objects even if they have not been specifically included in the training dataset (e.g., enabling systems for an open vocabulary). Open vocabulary panoptic segmentation aims to facilitate segmentation on arbitrary classes according to user input.

Aspects of some embodiments of the present disclosure provide for improvements to systems and methods for panoptic segmentation by using a retrieval-augmented approach.

Aspects of some embodiments of the present disclosure provide for a retrieval-augmented approach for panoptic segmentation, in which the system constructs a feature database for masked regions. At inference time, for both a cross-datasets setting and a training-free setting, the masked region features may be extracted from the input image and used as a retrieval key to retrieve similar features and associated class labels from the database. The masked region may be classified based on a similarity between the retrieval key and retrieval targets. The retrieval-based classification module may be combined with a CLIP-score classification module to improve open vocabulary panoptic segmentation performance.

Aspects of some embodiments of the present disclosure provide for improvements to panoptic segmentation using retrieval augmentation. For example, aspects of some embodiments of the present disclosure provide for systems with the capability to augment segmentation methods to work on a class (e.g., a new class), without specifically training system networks (e.g., ML models) for that class, by using retrieval augmentation to augment the knowledge of the system networks (e.g., trained networks). Augmentation may be performed at both the text-label level and the image-segmentation-mask level.

Aspects of some embodiments of the present disclosure provide for a retrieval augmentation module that uses segment-to-text embedding (e.g., CLIP-text embedding) to retrieve the closest label to construct a mask segment feature database, and clip-to-vision embedding (e.g., CLIP-vision embedding) of predicted masked segments to retrieve the closest class labels from the feature database.

Aspects of some embodiments of the present disclosure provide for a model for a cross-datasets setting that fuses a retrieval augmentation result with a frozen convolutional CLIP (FC-CLIP) result.

Aspects of some embodiments of the present disclosure provide for a model for a training-free setting that fuses a retrieval augmentation result with a segment anything model (SAM) result and a CLIP result.

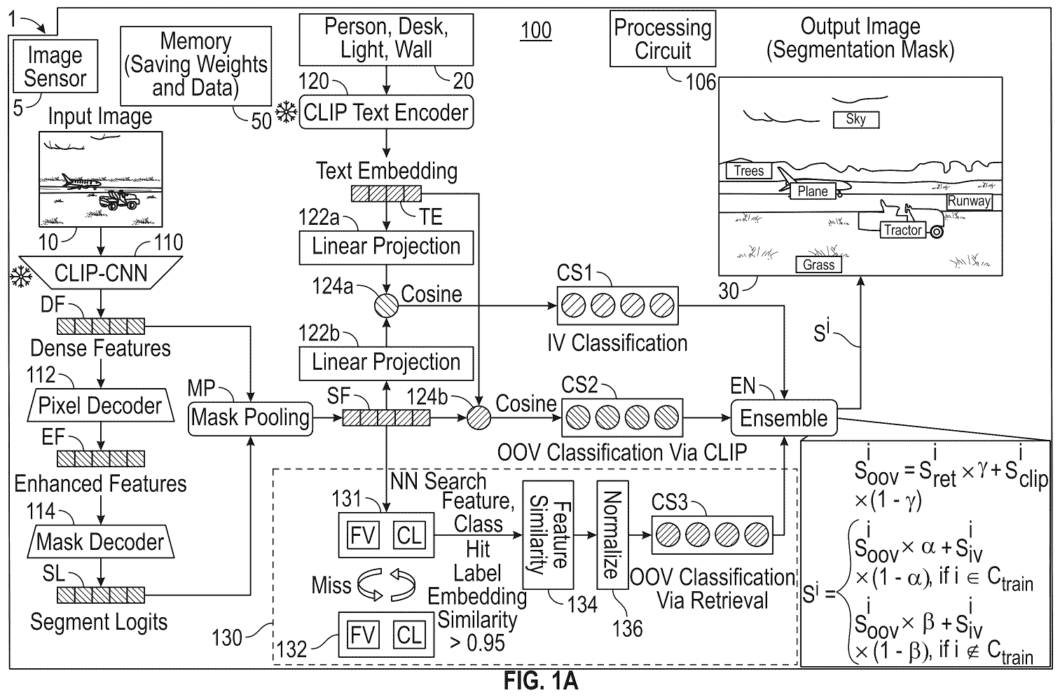

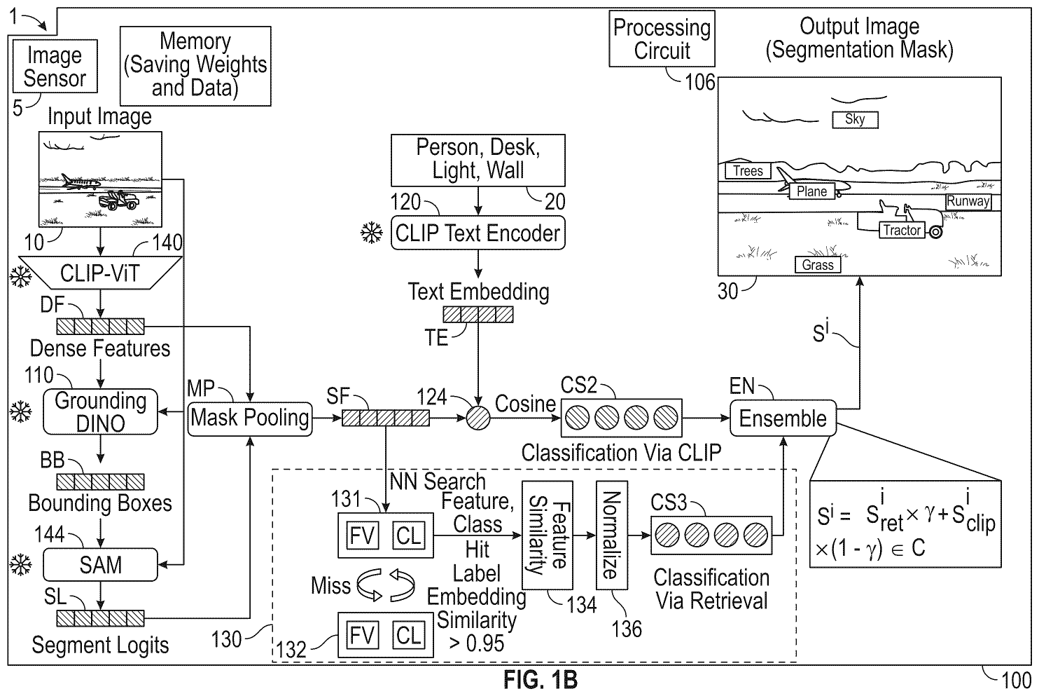

FIG. 1A is a block diagram depicting a system for classifying features from an input image in a cross-dataset setting, according to some embodiments of the present disclosure.

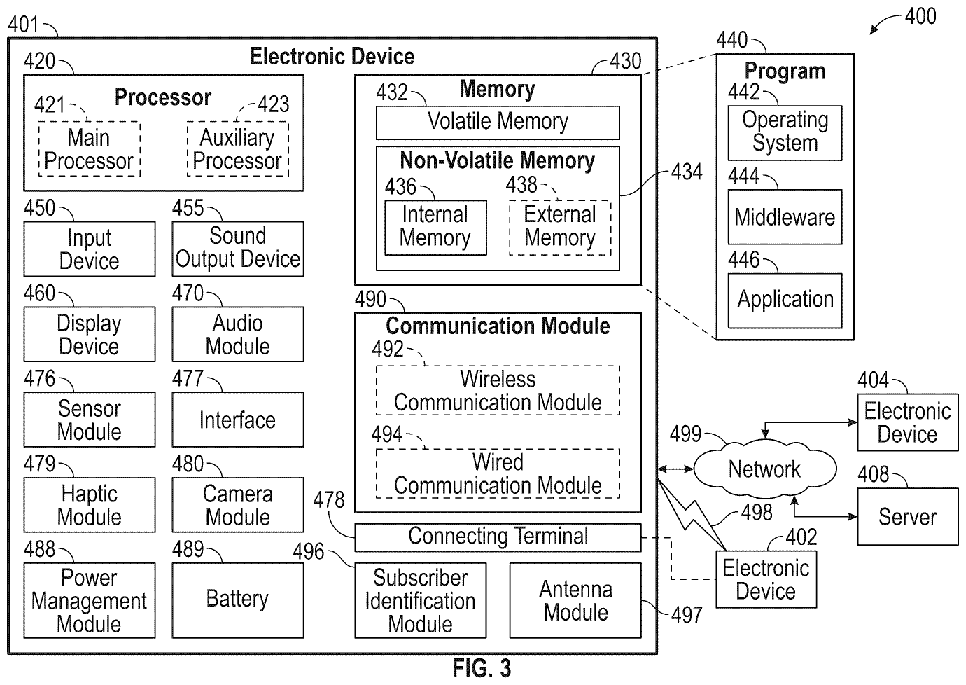

Referring to FIG. 1A, a system 1 for classifying features from an input image 10 may include a device 100 (e.g., a camera, a UE, a vehicle, a tablet, a computer, and/or the like). The device 100 may correspond to an electronic device 401 depicted in FIG. 3. The device 100 may include a processing circuit 106 (e.g., a CPU, GPU, NPU, and/or the like), a memory 50, and an image sensor 5 (e.g., a camera, a photoelectric sensor, and/or the like). The processing circuit 106 may correspond to a processor 420 depicted in FIG. 3. The memory 50 may correspond to a memory 430 depicted in FIG. 3. In some embodiments, the memory 50 may store weights and data for the ML models. The system 1 of FIG. 1A may be referred to as a cross-dataset setting because some of the models of the system 1 may be trained on a first dataset (e.g., a training dataset) and then applied to a second dataset (e.g., a target dataset) that is different from the first dataset. In some embodiments, the training dataset may include (e.g., may be) a common objects in context (COCO) dataset or an open image dataset of annotated images (e.g., a GOOGLE™ Open Image (GOI) dataset). In some embodiments, the target dataset (e.g., for testing) may be a sematic segmentation dataset with tens of thousands of scene-centric images annotated with pixel-level objects and object parts labels (e.g., ADE20k).

The processing circuit 106 may receive the input image 10 from the image sensor 5 and may perform processing of the input image to generate a segmentation mask as an output image 30 (e.g., an output segmentation mask). As used herein, a “segmentation mask” (also referred to as a feature map or a segmentation map) refers to image data (e.g., the output image) having one or more regions of related features that are classified to be understood by a computer. For example, a segmentation mask (e.g., the output image 30) may include a first classified region of features associated with a sky depicted in the input image 10, a second classified region of features associated with grass depicted in the input image 10, and a third classified region of features associated with one or more additional objects (e.g., an airplane, a tractor, a horse, and/or the like) of the input image 10.

Based on the different regions (e.g., related items) being classified in the output image 30, a computer (e.g., the device 100) may be able to perform operations associated with a variety of applications. For example, the device 100 may: generate metadata for the images, allowing the images (e.g., classified regions or features within the images) to be searched; apply different effects (such as lighting) to different areas (e.g., different classified regions or features) of the image; or allow for editing of the image (e.g., editing of classified regions or features within the images) based on the segmentation map (such as removing identified features). For example, the computer may be enabled to perform editing (e.g., efficient editing) of a scene depicted in the output image 30 or may be enabled to perform safe driving of an autonomous vehicle. For example, the computer may identify a segment feature in the segmentation mask as making up the sky and may add an effect to the sky in an image based on the segment feature. As another example, the computer may identify a segment feature in the segmentation mask as making up a road and may enable a vehicle to safely follow the road based on the segment feature.

The components and operations of the system 1 may be categorized according to two categories for an inferencing process. The first category of components and their operations may be referred to as mask proposal components and operations, and the second category of components and their operations may be referred to as segment classification components and operations.

In some embodiments, the mask proposal components and operations may include an object detector 110. As used herein, an “object detector” refers to a ML model that is configured to identify one or more objects or classes in image data. In some embodiments, the object detector 110 may be an ML model such as a CLIP convolutional neural network (CLIP-CNN). An output of the object detector 110 may include a bounding box associated with an object represented in the input image 10. The object detector 110 may be capable of detecting objects in the input image 10 and may generate dense features DF (e.g., image-level dense features, such as a one-dimensional vector) for performing mask pooling MP. In some embodiments, the object detector may be frozen. As used herein, “frozen” refers to an ML model (e.g., a neural network) that is pretrained and has weights that are prevented from being modified. In some embodiments, the dense features DF may be sent to a pixel decoder 112 to generate enhanced features EF. In some embodiments, the pixel decoder 112 may be tunable (e.g., finely tunable). In some embodiments, the enhanced features EF may be sent to a mask decoder 114 to generate segment logits SL (e.g., mask proposals) for mask pooling MP. The segment logits SL may indicate to which class each pixel belongs. In some embodiments, the mask decoder 114 may be tunable (e.g., finely tunable).

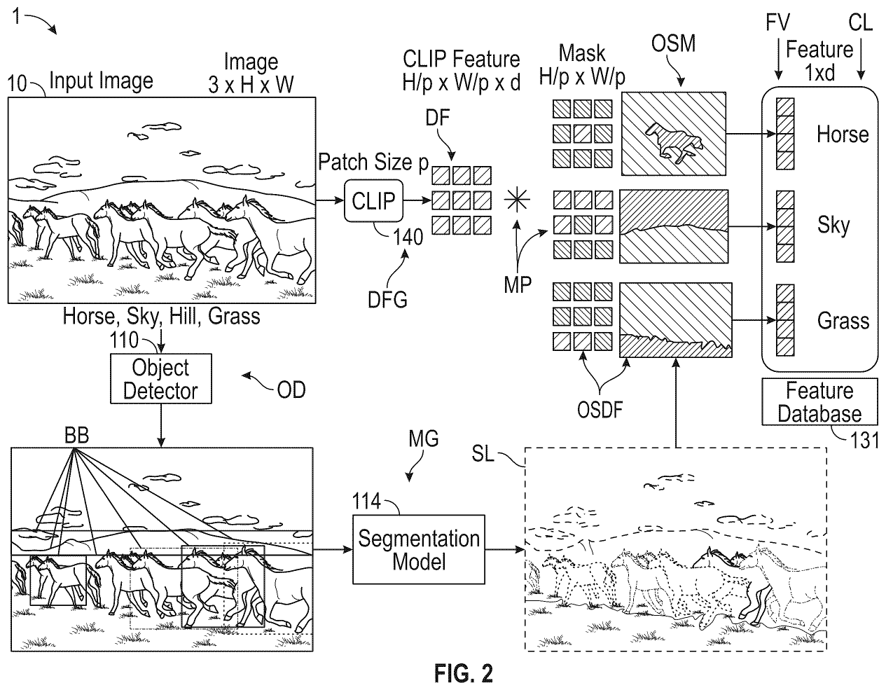

In some embodiments, the segment classification components and operations may include a retrieval augmentation circuit 130. The retrieval augmentation circuit 130 may include a feature database 131 (e.g., a database of segment features SF and associated class labels) and a fallback dataset 132 (e.g., a secondary dataset, which may be a large dataset, such as an open image dataset that includes high-level descriptions of the images) for extending (e.g., increasing) the feature database 131 over time to be able to handle out-of-vocabulary objects (e.g., out-of-vocabulary segment features) in the future. As used herein, an “out-of-vocabulary segment feature” refers to a segment feature that corresponds to an unseen object (e.g., an object not associated with a training dataset). As discussed in further detail below with reference to FIG. 2, the feature database 131 may be constructed (e.g., may be constructed before the inferencing process) to include classified segment features as feature vectors FV and their associated class labels CL (see FIG. 2).

In some embodiments, the system 1 may perform mask pooling MP (e.g., mask pooling operations, such as convolution operations) on the dense features DF and the segment logits SL to generate segment features SF (e.g., masked segment features), which may be class- or object-specific dense features. The process of generating the segment features SF based on the output of the object detector 110 may be referred to as segment-to-vision embedding (e.g., CLIP-vision embedding).

The retrieval augmentation circuit 130 may perform retrieval operations for out-of-vocabulary classification based on the masked segment features SF. The retrieval augmentation circuit 130 may use the masked segment features SF as retrieval keys to perform a retrieval search (e.g., a nearest-neighbor search, such as an approximate nearest-neighbor search) in the feature database 131. For example, the retrieval augmentation circuit 130 may perform a nearest-neighbor search based on a given segment feature SF (e.g., to find one or more feature vectors that are nearest the given segment feature SF).

An aspect of retrieval augmentation is the performance of a retrieval from the constructed feature database 131. For example, the processing circuit 106 may perform a similarity search, such as an exact search or a nearest-neighbor (NN) search (e.g., a k-NN search, such as an approximate nearest-neighbor search) in the feature database 131. Such a retrieval may be performed in both the cross-datasets setting of the system 1 depicted in FIG. 1A and the training-free setting of the system 1 depicted in FIG. 1B and discussed below. The approximate nearest-neighbor search may be more efficient (e.g., less computationally intensive) when searching among millions of retrieval targets (e.g., search targets). The exact search may be less efficient (e.g., more computationally intensive) when searching among millions of retrieval targets but may yield higher performance.

As discussed in further detail below, the feature database 131 may be constructed based on extracting classes from each image and creating layers within the feature database 131, with one layer for each class. For example, a first layer may be associated with a horse class, a second layer may be associated with a sky class, and a third layer may be associated with a grass class. The output image 30 may be generated more efficiently based retrieving feature vectors from the feature database 131 built around object-specific masks. Additionally, the feature database 131 may be extended to new classes based on building the feature database 131 with a combination of open vocabulary object detection via an object detector 110 and a segmentation model 144 (e.g., instead of relying on ground truth masks).

In some embodiments, if the retrieval search generates a hit in the feature database 131 (e.g., a sufficient match is found between a given retrieval key/segment feature SF and a feature vector FV found in the feature database 131), the retrieval augmentation circuit 130 may perform a feature similarity operation 134 to generate a distance score between the given retrieval key (e.g., the given segment features SF) and the feature vector FV (e.g., a retrieval target feature and its associated class label) found in the feature database 131. In some embodiments, the retrieval augmentation circuit 130 may perform normalization operations on the resulting distance scores to normalize the distance scores to generate retrieval-based classification scores CS3. For example, the retrieval augmentation circuit 130 may perform min-max normalization and may subtract the results from the number one to place the scores within a range of zero to one.

In some embodiments, if the retrieval search generates a miss in the feature database 131 (e.g., a sufficient match is not found between a given retrieval key/segment feature SF and a feature vector FV found in the feature database 131), the retrieval augmentation circuit 130 may perform a search (e.g., a similarity search) in the fallback dataset 132. In other words, in the event of a retrieval miss, the fallback dataset may be utilized to expand the feature database 131. In some embodiments, a “miss” indicates that none of the feature vectors FV in the feature database 131 is sufficiently close to a given segment feature SF triggering the search.

In case any user-provided class names are missing from the feature database 131, the retrieval augmentation circuit 130 may retrieve image samples for the missing input classes from the fallback dataset 132. In some embodiments, the label matching (e.g., the matching of class labels CL) between datasets (e.g., between a missing input class and a retrieved image sample/feature vector FV) may be performed with text embedding (e.g., with CLIP text embedding) of class names with similarity scores that satisfy a threshold (e.g., a similarity score that is greater than about 0.95). For example, if a retrieval search generates a miss in the feature database 131, the retrieval augmentation circuit 130 may search the fallback dataset 132 to search for label embeddings (e.g., class labels CL) having similarity scores that are greater than a (pre-) configured threshold. The retrieved image samples and their label embeddings may be stored in the feature database 131 to extend the feature database 131 to provide matches for a greater variety of segment features SF over the long term (e.g., for a subsequent similarity search).

In some embodiments, the retrieval augmentation circuit 130 may send the retrieval-based classification scores CS3 to an ensemble circuit EN. The ensemble circuit EN may combine outputs (e.g., classification scores) from multiple classification methods to generate final results (e.g., final segmentation scores s′) and create the output image 30 based on the final results. For example, the ensemble circuit EN may determine final segmentation scores s′ from three classification pipelines. The three classification pipelines may include: a first pipeline for in-vocabulary (IV) classification (e.g., for common objects included in a training dataset) used to generate IV classification scores CS1; a second pipeline for out-of-vocabulary (OOV) classification via CLIP to generate OOV classification via CLIP scores CS2 (e.g., for unseen objects not included in a training dataset); and a third pipeline for OOV classification via retrieval to generate the retrieval-based classification scores CS3, as discussed above. The scores CS1, CS2, and CS3 may be probabilities indicating how likely a segment feature SF generated from the input image 10 is to correspond to a retrieved feature vector FV. For example, a given score may indicate how likely a given segment feature SF from the input image 10 is to belong to a given object/class (e.g., an airplane, a tractor, a horse, a sky, grass, and/or the like).

Still referring to FIG. 1A, the IV classification scores CS1 and the OOV classification scores CS2 may both be generated based on input text 20 (e.g., a set of class names) that is pre-configured or received from a user or from an application running on the device 100 or communicatively connected to the device 100. For example, the set of class names may include all the nouns of a given vocabulary. As an open-vocabulary system, the system 1 may be able to work on classes that are not included in a training dataset (e.g., the input text 20 may correspond to an arbitrary number of classes). The input text 20 may be received by a CLIP text encoder 120 to generate text embeddings TE (e.g., dense features associated with each class name). In some embodiments, the CLIP text encoder 120 may be frozen. For example, the CLIP text encoder 120 may be an FC-CLIP model.

As an example of out-of-vocabulary classification, if the input text 20 includes a horse class but the training dataset did not include the horse class (or no training dataset exists), then the horse class may be classified based on at least one of the out-of-vocabulary channels (e.g., the channels associated with the OOV classification via CLIP scores CS2 and/or the retrieval-based classification scores CS3).

In some embodiments, the IV classification scores CS1 may be generated from the output of a first similarity operation 124a (e.g., a cosine operation) performed on a first linear projection result 122a and a second linear projection result 122b. The first linear projection result 122a may be generated based on a linear projection operation performed on the text embeddings TE. The second linear projection result 122b may be generated based on a linear projection operation performed on the segment features SF. In some embodiments, the linear projection operations may be performed based on tunable (e.g., trainable) parameters. In summary, in the cross-dataset setting, the pixel decoder 112, the mask decoder, and the linear projections 122a and 122b may include (e.g., may be) trainable parameters that are trained prior to the inferencing process and may be tunable (e.g., may be fine-tuned on pixel-level panoptic annotations prior to the inferencing process), which may improve segment classification for higher performance on common objects in the input image 10. That is, tuning a parameter refers to finetuning (or training) the parameter from a dataset. For example, the pixel-level panoptic annotations may originate from the COCO dataset. This setting may be more useful when a large dataset is already available for training.

In some embodiments, the OOV classification via CLIP scores CS2 may be generated from the output of a second similarity operation 124b (e.g., a cosine operation) performed on the text embeddings TE and the segment features SF.

In some embodiments, as discussed above, the ensemble circuit EN may combine the outputs (e.g., the classification scores) of more than one classification method to generate final segmentation scores sⁱ used to generate the output image 30. For example, the ensemble circuit EN may be used to fuse the output (e.g., the outputs) generated based on the CLIP text encoder 120 with the output from the retrieval augmentation circuit 130. In other words, the retrieval augmentation circuit 130 (also referred to as a retrieval-based classification module or a retrieval-based classification circuit) may be combined with a score-based classification circuit (e.g., a CLIP-score classification module, also referred to as a CLIP-score classification circuit) to improve open vocabulary panoptic segmentation performance. The score-based classification circuit may include the text encoder 120, IV classification scores CS1, and/or OOV classification via CLIP scores CS2.

In some embodiments, final segmentation scores sⁱ may be determined based on:

$${s}_{oov}^{i} = {s}_{ret}^{i} \times γ + {s}_{clip}^{i} \times ( 1 - γ ) \qquad ( equation 1.1 )$$

$$and$$

$${s}^{i} = \{ \begin{matrix}{s}_{oov}^{i} \times α + {s}_{iv}^{i} \times ( 1 - α ) , & if i ∈ {C}_{train} \\ {s}_{oov}^{i} \times β + {s}_{iv}^{i} \times ( 1 - β ) , & if i ∉ {C}_{train}\end{matrix} \qquad ( equation 1.2 )$$

in which: C refers to the set of classes for prediction; Cₜᵣₐᵢₙ refers to the set of classes in the fine-tuning dataset;

$${s}_{clip}^{i} , {s}_{ret}^{i} , and {s}_{iv}^{i}$$

respectively refer to classification scores for class i using CLIP (e.g., the OOV classification via CLIP scores CS2), using the retrieval augmentation circuit 130 (e.g., the retrieval-based classification scores CS3), and using the IV classifier (e.g., the IV classification scores CS1); and α, β, and γ refer to hyper-parameters.

FIG. 1B is a block diagram depicting a system 1 for classifying features from an input image 10 in a training-free setting, according to some embodiments of the present disclosure.

Referring to FIG. 1B, in the training-free setting, unlike in the cross-dataset setting, the system components may not be fine-tuned on pixel-level panoptic annotations. For example, a CLIP model 140 (e.g., a CLIP vision transformer (CLIP-ViT) model), an object detector 110, a segmentation model 144 (e.g., an SAM), and a CLIP text encoder 120 may be frozen (e.g., may use pretrained models for zero-shot training). In some embodiments, the object detector 110, which may be an open vocabulary object detection model, and the segmentation model 144 (e.g., an SAM) may be used for mask proposal generation.

For example, in some embodiments, the mask proposal components may include the CLIP model 140, the object detector 110, and the segmentation model 144. The operations of the mask proposal components are discussed below with reference to FIG. 2 in the context of constructing the feature database 131. For example, the segment features SF of the system 1 for classifying features in a training-free setting may be generated by sending input-image data from the input image 10 to the object detector 110, and sending an output of the object detector 110 to a segmentation model 144. In some embodiments, the object detector 110 may include (e.g., may be) a detection transformer with improved denoising anchor boxes (DINO), such as a grounding DINO. A grounding DINO is a zero-shot object detection model that combines a DINO architecture with grounded pre-training to detect arbitrary objects based on user inputs (e.g., user-supplied categories). The output of the object detector 110 may include bounding boxes BB associated with one or more objects represented in the input image 10. In some embodiments, the segmentation model 144 may include (e.g., may be) a segment anything model (SAM).

In some embodiments, the segment classification may be performed with the CLIP text encoder 120 and the retrieval augmentation circuit 130. The OOV classification via CLIP scores CS2 and the retrieval-based classification scores C3 may be generated as in the cross-dataset setting of FIG. 1A. However, unlike the system 1 of FIG. 1A, there may be no pipeline for IV classification. The training-free system 1 of FIG. 1B may be more helpful for classifying objects off-the-shelf, without dataset development or training (e.g., when a large dataset is not available for training). Accordingly, each segment feature SF may be referred to as out-of-vocabulary because the correspond to unseen objects not associated with a training dataset.

The process of generating the segment features SF based on the output of the CLIP model 140 may be referred to as segment-to-vision embedding (e.g., CLIP-vision embedding).

In some embodiments, final segmentation scores sⁱ for the training-free setting may be determined based on two classification pipelines, combined as follows:

$${s}^{i} = {s}_{ret}^{i} \times γ + {s}_{clip}^{i} \times ( 1 - γ ) \qquad ( equation 1.3 )$$

in which:

$${s}_{clip}^{i} and {s}_{ret}^{i}$$

respectively refer to classification scores for class i using CLIP (e.g., the OOV classification via CLIP scores CS2) and using the retrieval augmentation circuit 130 (e.g., the retrieval-based classification scores CS3); and γ refers to the hyper-parameter.

In summation, the retrieval augmentation circuit 130 may augment segmentation methods to work on a class (e.g., a new class), without specifically training system networks (e.g., ML models) for that class. The retrieval augmentation circuit 130 may augment the knowledge of the system networks at the text-label level (e.g., based on the outputs of the text encoder 120) and/or at the image-segmentation-mask level (e.g., based on the outputs of the object detector 110).

FIG. 2 is a block diagram depicting a method for constructing a feature database for the systems of FIGS. 1A and 1B, according to some embodiments of the present disclosure.

As discussed above, aspects of some embodiments of the present disclosure include retrieval augmentation to augment segmentation methods to work on new classes, without training for the new classes. Retrieval augmentation may be used by (e.g., may be implemented in) the cross-datasets setting of the system 1 depicted in FIG. 1A and the training-free setting of the system 1 depicted in FIG. 1B to augment (e.g., to increase and/or to improve) the knowledge of the trained network (e.g., the trained ML models of the system 1). In some embodiments, augmentation may be used at both the text-label level and the image-segmentation-mask level.

Referring to FIG. 2, one component of retrieval augmentation is the construction of a masked image feature database (e.g., the feature database 131) with text labels. For example, the system 1 (e.g., the processing circuit 106), may receive a paired image-text dataset as an input and may convert the paired image-text dataset into a database (e.g., the feature database 131) of masked segment features (e.g., the feature vectors FV) and associated class labels CL. In some embodiments, the construction of the feature database 131 (also referred to as database construction) may include four operations (e.g., four stages): object detection OD, mask generation MG, dense feature generation DFG, and mask pooling MP.

In some embodiments, for object detection OD, an image (e.g., the input image 10) and class labels present in the image may be fed to (e.g., sent to) an object detector 110 (e.g., an open vocabulary object detector). In some embodiments, the object detector 110 may include (e.g., may be) a DINO, such as a grounding DINO. An output of the object detector 110 may include one or more bounding boxes (e.g., class-aware bounding boxes) associated with each class (e.g., each object) present in the input image 10.

In some embodiments, for mask generation MG, the input image 10 and associated bounding boxes BB (e.g., bounding box prompts) may be fed to (e.g., sent to) the segmentation model 144 (e.g., an SAM) for mask generation. Even though a given SAM may be capable of generating masks without class-aware bounding boxes, the resulting masks (generated without class-aware bounding boxes) may break up a single class (e.g., a car) into multiple masks (e.g., a wheel mask, a car body mask, a window mask, and/or the like). Generating class-aware masks with the object detector 110 and sending the class-aware masks to the segmentation model 144 may enable the segmentation model 144 to generate high-quality masks for each class present in the input image 10.

As discussed above, the combination of the object detector 110 being an open vocabulary object detector and having an output provided to a segmentation model 144 may allow for suitable segmentation performance when retrieval augmentation is applied to new objects not included in a training dataset.

In some embodiments, for dense feature generation DFG, the system 1 may use a pre-trained ML model (e.g., a CLIP model 140) to extract dense features DF (e.g., image-level dense features for the whole image) from the input image 10. For example, if the input image 10 has: a shape of H×W×3, a patch size of CLIP of p, and a dimension of the dense feature of d, then the shape of the output dense feature DF would be equal to:

$$\frac{H}{p} \times \frac{W}{p} \times d \qquad ( equation 2 )$$

wherein H refers to a height of the image, and W refers to a width of the image.

In some embodiments, for mask pooling MP, the system 1 may take the dense features DF associated with the whole input image 10 and generate object-specific dense features OSDF (e.g., class-specific dense features) based on masks (e.g., based on segment logits SL) generated by the segmentation model 144 at the stage of mask generation MG, instead of encoding each masked segment using CLIP separately, which may be computationally expensive. A mask-pooling operation (e.g., a convolution operation) may generate a d dimensional feature vector FV for each masked segment. The features (e.g., the feature vectors FV) and associated class labels CL may be added to the feature database 131.

In summation, in some embodiments, the system 1 may generate an object-specific segmentation mask OSM (e.g., a binary segmentation mask) separately for each class in the input image 10. The system 1 may store a given object-specific mask OSM, as a given feature vector FV with a given class label CL (e.g., closest matching class label). The system 1 may do this for each layer (e.g., each class) of the input image 10, as opposed to constructing a feature database from a feature associated with the entire input image 10. The process of generating the given object-specific mask OSM as the given feature vector FV and associating the feature vector FV with a closest class label CL may be referred to as segment-to-text embedding (e.g., CLIP-text embedding).

In summation, the retrieval augmentation circuit 130 (also referred to as retrieval augmentation module) may use segment-to-text embedding (e.g., CLIP-text embedding) to retrieve the closest class labels to construct the feature database 131 (also referred to as a mask segment feature database) and may use segment-to-vision embedding (e.g., CLIP-vision embedding) of predicted masked segments to retrieve the closest class labels from the feature database 131. In other words, the retrieval augmentation circuit 130 may use the outputs generated based on the CLIP model 140 (e.g., generated using segment-to-text embedding) (see, e.g., FIG. 2) to construct the feature database 131 and may use the outputs generated based on the object detector 110 (e.g., using segment-to-vision embedding) (see, e.g., FIGS. 1A and 1B) to retrieve the closest class labels from the feature database 131.

FIG. 3 is a block diagram of an electronic device in a network environment, according to some embodiments of the present disclosure.

Referring to FIG. 3, the electronic device 401 in a network environment 400 may communicate with an electronic device 402 via a first network 498 (e.g., a short-range wireless communication network), or an electronic device 404 or a server 408 via a second network 499 (e.g., a long-range wireless communication network). The electronic device 401 may communicate with the electronic device 404 via the server 408. The electronic device 401 may include the processor 420, the memory 430, an input device 450, a sound output device 455, a display device 460, an audio module 470, a sensor module 476, an interface 477, a haptic module 479, a camera module 480, a power management module 488, a battery 489, a communication module 490, a subscriber identification module (SIM) card 496, or an antenna module 497. In one embodiment, at least one (e.g., the display device 460 or the camera module 480) of the components may be omitted from the electronic device 401, or one or more other components may be added to the electronic device 401. Some of the components may be implemented as a single integrated circuit (IC). For example, the sensor module 476 (e.g., a fingerprint sensor, an iris sensor, or an illuminance sensor) may be embedded in the display device 460 (e.g., a display).

The processor 420 may execute software (e.g., a program 440) to control at least one other component (e.g., a hardware or a software component) of the electronic device 401 coupled with the processor 420 and may perform various data processing or computations.

As at least part of the data processing or computations, the processor 420 may load a command or data received from another component (e.g., the sensor module 476 or the communication module 490) in volatile memory 432, process the command or the data stored in the volatile memory 432, and store resulting data in non-volatile memory 434. The processor 420 may include a main processor 421 (e.g., a central processing unit (CPU) or an application processor (AP)), and an auxiliary processor 423 (e.g., a graphics processing unit (GPU), an image signal processor (ISP), a sensor hub processor, or a communication processor (CP)) that is operable independently from, or in conjunction with, the main processor 421. Additionally or alternatively, the auxiliary processor 423 may be adapted to consume less power than the main processor 421, or execute a particular function. The auxiliary processor 423 may be implemented as being separate from, or a part of, the main processor 421.

The auxiliary processor 423 may control at least some of the functions or states related to at least one component (e.g., the display device 460, the sensor module 476, or the communication module 490) among the components of the electronic device 401, instead of the main processor 421 while the main processor 421 is in an inactive (e.g., sleep) state, or together with the main processor 421 while the main processor 421 is in an active state (e.g., executing an application). The auxiliary processor 423 (e.g., an image signal processor or a communication processor) may be implemented as part of another component (e.g., the camera module 480 or the communication module 490) functionally related to the auxiliary processor 423.

The memory 430 may store various data used by at least one component (e.g., the processor 420 or the sensor module 476) of the electronic device 401. The various data may include, for example, software (e.g., the program 440) and input data or output data for a command related thereto. The memory 430 may include the volatile memory 432 or the non-volatile memory 434. Non-volatile memory 434 may include internal memory 436 and/or external memory 438.

The program 440 may be stored in the memory 430 as software, and may include, for example, an operating system (OS) 442, middleware 444, or an application 446.

The input device 450 may receive a command or data to be used by another component (e.g., the processor 420) of the electronic device 401, from the outside (e.g., a user) of the electronic device 401. The input device 450 may include, for example, a microphone, a mouse, or a keyboard.

The sound output device 455 may output sound signals to the outside of the electronic device 401. The sound output device 455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 460 may visually provide information to the outside (e.g., a user) of the electronic device 401. The display device 460 may include, for example, a display, a hologram device, or a projector and control circuitry to control a corresponding one of the display, hologram device, and projector. The display device 460 may include touch circuitry adapted to detect a touch, or sensor circuitry (e.g., a pressure sensor) adapted to measure the intensity of force incurred by the touch.

The audio module 470 may convert a sound into an electrical signal and vice versa. The audio module 470 may obtain the sound via the input device 450 or output the sound via the sound output device 455 or a headphone of an external electronic device 402 directly (e.g., wired) or wirelessly coupled with the electronic device 401.

The sensor module 476 may detect an operational state (e.g., power or temperature) of the electronic device 401 or an environmental state (e.g., a state of a user) external to the electronic device 401, and then generate an electrical signal or data value corresponding to the detected state. The sensor module 476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 477 may support one or more specified protocols to be used for the electronic device 401 to be coupled with the external electronic device 402 directly (e.g., wired) or wirelessly. The interface 477 may include, for example, a high-definition multimedia interface (HDMI), a universal serial bus (USB) interface, a secure digital (SD) card interface, or an audio interface.

A connecting terminal 478 may include a connector via which the electronic device 401 may be physically connected with the external electronic device 402. The connecting terminal 478 may include, for example, an HDMI connector, a USB connector, an SD card connector, or an audio connector (e.g., a headphone connector).

The haptic module 479 may convert an electrical signal into a mechanical stimulus (e.g., a vibration or a movement) or an electrical stimulus which may be recognized by a user via tactile sensation or kinesthetic sensation. The haptic module 479 may include, for example, a motor, a piezoelectric element, or an electrical stimulator.

The camera module 480 may capture a still image or moving images. The camera module 480 may include one or more lenses, image sensors, image signal processors, or flashes. The power management module 488 may manage power supplied to the electronic device 401. The power management module 488 may be implemented as at least part of, for example, a power management integrated circuit (PMIC).

The battery 489 may supply power to at least one component of the electronic device 401. The battery 489 may include, for example, a primary cell which is not rechargeable, a secondary cell which is rechargeable, or a fuel cell.

The communication module 490 may support establishing a direct (e.g., wired) communication channel or a wireless communication channel between the electronic device 401 and the external electronic device (e.g., the electronic device 402, the electronic device 404, or the server 408) and performing communication via the established communication channel. The communication module 490 may include one or more communication processors that are operable independently from the processor 420 (e.g., the AP) and supports a direct (e.g., wired) communication or a wireless communication. The communication module 490 may include a wireless communication module 492 (e.g., a cellular communication module, a short-range wireless communication module, or a global navigation satellite system (GNSS) communication module) or a wired communication module 494 (e.g., a local area network (LAN) communication module or a power line communication (PLC) module). A corresponding one of these communication modules may communicate with the external electronic device via the first network 498 (e.g., a short-range communication network, such as BLUETOOTH™, wireless-fidelity (Wi-Fi) direct, or a standard of the Infrared Data Association (IrDA)) or the second network 499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 492 may identify and authenticate the electronic device 401 in a communication network, such as the first network 498 or the second network 499, using subscriber information (e.g., international mobile subscriber identity (IMSI)) stored in the subscriber identification module 496.

The antenna module 497 may transmit or receive a signal or power to or from the outside (e.g., the external electronic device) of the electronic device 401. The antenna module 497 may include one or more antennas, and, therefrom, at least one antenna appropriate for a communication scheme used in the communication network, such as the first network 498 or the second network 499, may be selected, for example, by the communication module 490 (e.g., the wireless communication module 492). The signal or the power may then be transmitted or received between the communication module 490 and the external electronic device via the selected at least one antenna.

Commands or data may be transmitted or received between the electronic device 401 and the external electronic device 404 via the server 408 coupled with the second network 499. Each of the electronic devices 402 and 404 may be a device of a same type as, or a different type, from the electronic device 401. All or some of operations to be executed at the electronic device 401 may be executed at one or more of the external electronic devices 402, 404, or 408. For example, if the electronic device 401 should perform a function or a service automatically, or in response to a request from a user or another device, the electronic device 401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 401. The electronic device 401 may provide the outcome, with or without further processing of the outcome, as at least part of a reply to the request. To that end, a cloud computing, distributed computing, or client-server computing technology may be used, for example.

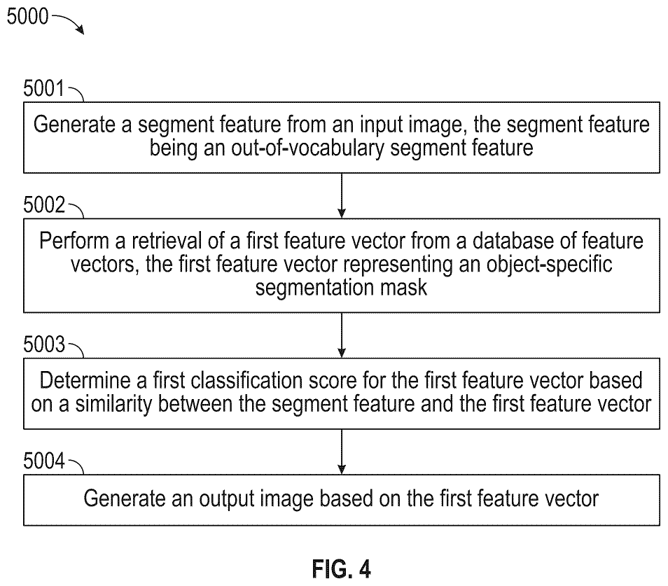

FIG. 4 is a flowchart depicting example operations of a method 5000 for classifying features from an input image 10, according to some embodiments of the present disclosure.

Referring to FIG. 4, the method 5000 may include one or more of the following operations. A processing circuit 106 of a device 100 (e.g., a camera, a UE, a vehicle, a tablet, a computer, and/or the like) may generate a segment feature SF from the input image 10 (operation 5001). The segment feature SF may be an out-of-vocabulary segment feature. The processing circuit 106 may perform a retrieval of a first feature vector FV from a database of feature vectors (e.g., the feature database 131) (operation 5002). The first feature vector FV may correspond to (e.g., may represent) an object-specific segmentation mask OSM. The first feature vector FV may be stored in the database of feature vectors as part of a construction process for the database of feature vectors. The processing circuit 106 may determine a first classification score (e.g., a retrieval-based classification score CS3) based on a similarity between the segment feature SF and the first feature vector FV (operation 5003). The processing circuit 106 may generate an output image 30 (e.g., an output segmentation mask) based on the first feature vector FV and the first classification score (operation 5004).

As discussed above with reference to FIG. 1A, based on different regions (e.g., related items) being classified in the output image 30, the device 100 may be able to perform operations associated with a variety of applications. For example, the device 100 may: generate metadata for the output image 30, allowing the output image 30 to be searched; apply different effects (such as lighting) to different areas of the output image 30; or allow for editing of the image (e.g., editing of classified regions or features within the image) based on the output image 30 (such as removing identified features). For example, the device 100 may be enabled to perform editing (e.g., efficient editing) of a scene depicted in the output image 30 or may be enabled to perform safe driving of an autonomous vehicle. For example, the device 100 may identify a segment feature in the segmentation mask as making up the sky and may add an effect to the sky in the output image 30 based on the segment feature. As another example, the device 100 may identify a segment feature in the output image 30 as making up a road and may enable a vehicle to safely follow the road based on the segment feature.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for classifying features from input images, the method comprising:
generating, by a processing circuit, a segment feature from a first input image, the segment feature corresponding to a group of pixels associated with an object represented in the first input image, and being an out-of-vocabulary segment feature;
performing, by the processing circuit, a retrieval of a first feature vector, corresponding to the segment feature, from a database of feature vectors, the first feature vector representing an object-specific segmentation mask; and
generating, by the processing circuit, an output segmentation mask based on the first feature vector.

2. The method of claim 1, further comprising:
generating a first classification score for the segment feature based on an output of a CLIP text encoder;
generating a second classification score for the first feature vector based on a similarity between the segment feature and the first feature vector; and
determining a final segmentation score based on the first classification score and the second classification score,
wherein the output segmentation mask is generated based on the final segmentation score.

3. The method of claim 1, further comprising generating the segment feature by:
sending input image data from the first input image to an object detector; and
sending an output of the object detector to a segmentation model.

4. The method of claim 1, further comprising generating the segment feature based on sending a dense feature from the first input image to a pixel decoder.

5. The method of claim 1, further comprising generating the database of feature vectors by:
sending a dense feature from a second input image to an object detector;
sending an output of the object detector to a segmentation model to generate a mask proposal;
generating the object-specific segmentation mask based on the mask proposal; and
generating the first feature vector based on the object-specific segmentation mask.

6. The method of claim 1, wherein:
the first feature vector is generated based on segment-to-text embedding; and
the segment feature is generated based on segment-to-vision embedding.

7. The method of claim 1, wherein the performing of the retrieval comprises performing a nearest-neighbor search based on the segment feature.

8. The method of claim 1, further comprising:
performing a search in the database of feature vectors based on a second segment feature; and
based on the search resulting in a miss, retrieving a second feature vector from a secondary dataset.

9. A system comprising:
a processing circuit; and
a memory storing instructions that, based on being executed by the processing circuit, cause the processing circuit to perform:
generating a segment feature from a first input image, the segment feature corresponding to a group of pixels associated with an object represented in the first input image, and being an out-of-vocabulary segment feature;
a retrieval of a first feature vector, corresponding to the segment feature, from a database of feature vectors, the first feature vector representing an object-specific segmentation mask; and
generating an output segmentation mask based on the first feature vector.

10. The system of claim 9, wherein the instructions, based on being executed by the processing circuit, cause the processing circuit to perform:
generating a first classification score for the segment feature based on an output of a CLIP text encoder;
generating a second classification score for the first feature vector based on a similarity between the segment feature and the first feature vector; and
determining a final segmentation score based on the first classification score and the second classification score,
wherein the output segmentation mask is generated based on the final segmentation score.

11. The system of claim 9, wherein the instructions, based on being executed by the processing circuit, cause the processing circuit to perform:
generating the segment feature by:
sending input-image data from the first input image to an object detector; and
sending an output of the object detector to a segmentation model.

12. The system of claim 9, wherein the instructions, based on being executed by the processing circuit, cause the processing circuit to perform:
generating the segment feature based on sending a dense feature from the first input image to a pixel decoder.

13. The system of claim 9, wherein the instructions, based on being executed by the processing circuit, cause the processing circuit to perform:
generating the database of feature vectors by:
sending a dense feature from a second input image to an object detector;
sending an output of the object detector to a segmentation model to generate a mask proposal;
generating the object-specific segmentation mask based on the mask proposal; and
generating the first feature vector based on the object-specific segmentation mask.

14. The system of claim 9, wherein:
the first feature vector is generated based on segment-to-text embedding; and
the segment feature is generated based on segment-to-vision embedding.

15. The system of claim 9, wherein the performing of the retrieval comprises performing a nearest-neighbor search based on the segment feature.

16. The system of claim 9, wherein the instructions, based on being executed by the processing circuit, cause the processing circuit to perform:
a search in the database of feature vectors based on a second segment feature; and
based on the search resulting in a miss, retrieving a second feature vector from a secondary dataset.

17. A device comprising:
an image sensor configured to generate an input image; and
a means for processing, the means for processing being configured to perform a method for classifying features from the input image, the method comprising:
generating, by the means for processing, a segment feature from a first input image, the segment feature corresponding to a group of pixels associated with an object represented in the first input image, and being an out-of-vocabulary segment feature;
performing, by the means for processing, a retrieval of a first feature vector, corresponding to the segment feature, from a database of feature vectors, the first feature vector representing an object-specific segmentation mask; and
generating, by the means for processing, an output segmentation mask based on the first feature vector.

18. The device of claim 17, wherein the method further comprises:
generating a first classification score for the segment feature based on an output of a CLIP text encoder;
generating a second classification score for the first feature vector based on a similarity between the segment feature and the first feature vector; and
determining a final segmentation score based on the first classification score and the second classification score,
wherein the output segmentation mask is generated based on the final segmentation score.

19. The device of claim 17, wherein the method further comprises generating the segment feature by:
sending input-image data from the first input image to an object detector; and
sending an output of the object detector to a segmentation model.

20. The device of claim 17, wherein the method further comprises generating the segment feature based on sending a dense feature from the first input image to a pixel decoder.
